(19) United States
(12) Patent Application Publication
(10) Pub. No.: US 2013/0229417 A1
(43) Pub. Date: Sep. 5, 2013

(54) Method and Device for Displaying Values in a Vehicle

(71) Applicants: Peter Brenner, Weil im Schoenbuch (DE); Vera Schmidt, Palo Alto, CA (US)

(72) Inventors: Peter Brenner, Weil im Schoenbuch (DE); Vera Schmidt, Palo Alto, CA (US)

(73) Assignee: DAIMLER AG, Stuttgart (DE)

(21) Appl. No.: 13/823,275

(22) PCT Filed: Oct. 7, 2011
(86) PCT No.: PCT/EP2011/005006

§ 371 Date: May 21, 2013

(30) Foreign Application Priority Data
Nov. 4, 2010 (DE) 10 2010 050 412.2

(51) Int. Cl. G06T 11/20

(52) U.S. Cl. CPC G06T 11/206
USPC 345/440

(57) ABSTRACT

A method for displaying a value on a display device of a vehicle in which a circular dial with a predetermined range of values in a first angle range of a full or partial circle and an indicator pointing to the value of the circular dial to be indicated are graphically depicted. The scaling of the circular dial is altered and the circular dial is then displayed in a second angle range smaller than the first angle range, in keeping with the changed scaling. This provides additional space for displaying other information.

### BACKGROUND AND SUMMARY OF THE INVENTION

Exemplary embodiments of the present invention are directed to a method for displaying a value on a display device in a vehicle through graphical representation of a circular dial with a predetermined range of values in a first angle range of a full or partial circle and graphical depiction of an indicator pointing to the value of the circular dial to be indicated. In addition, exemplary embodiments of the present invention are directed to a method for displaying a value and an image on a display device of a vehicle having a predetermined display surface through graphical depiction of a scale with a predetermined range of values in a first section of the display surface, graphical depiction of an indicator pointing to the value of the scale to be indicated, and graphical depiction of the image in a second section of the display surface. Exemplary embodiments of the present invention are also directed to corresponding display devices.

In vehicles, and particularly in motor vehicles, display instruments are used in order to represent to the driver current values concerning the vehicle or the environment. Thus, for example, the vehicle speed, engine RPM, engine temperature, or fuel level are represented. This representation is often carried out by means of “instrument tubes”. Thus a typical tachometer is frequently tubular in shape, with a circular dial to represent the range of values the instrument can display. In the center of the instrument tube is an indicator, which points to the current value of the circular dial.

In modern vehicles, instrument clusters are used to display the current vehicle or ambient values or images. These have a large display screen on which images and virtual instruments can be displayed. Display instruments, for example, are depicted as virtual instrument tubes with a scaled ring.

Display images such as, e.g., displays for driver assistance systems, vehicle settings, night view systems, navigation displays, etc. are restricted to the area outside the scaled rings on instrument clusters. The area between the scaled rings of the speedometer, tachometer and clock are often used to display such images.

Complex display information, however, tends to require a larger display surface than is available between the scaled rings. Thus, a dynamic expansion of the display surface is used, in which the scaled ring images are faded out and the area of the display surface thus made available is then used as an image display surface. This has the drawback, however that the tachometer, thermometer, etc. otherwise represented are no longer displayed.

An alternative solution to expand the size of the display surface involves replacing a standard scaled ring tachometer with a bar tachometer requiring a smaller display area. A drawback here is that the graphical depiction, and thus also the visual perception or legibility of the instrument, changes completely if, for example, the night view assistance system is activated.

Exemplary embodiments of the present invention provide as much display surface area as possible, including for more complex display images, while changing the visual perception or legibility of the instruments as little as possible.

Exemplary embodiments of the present invention are directed to a method to display a value on a display device of a vehicle through graphical depiction of a circular dial with a predetermined range of values in a first angle range of a full or partial circle and graphical depiction of an indicator pointing to the value of the circular dial to be indicated, with the scaling of the circular dial changed and the circular dial depicted, in keeping with the altered scaling, in a second angle range smaller than the first angle range.

Thus, by only altering the scaling additional space for further displays can be advantageously created while retaining the circular dial form and the diameter or radius of the circular dial, in that the unused area of the circular dial is used for other types of displays. In so doing, visual perception of the display device is almost unchanged.

The transition between the depiction of the circular dial from the first angle range to the second angle range is effected preferably via animation. In this way, the change in the depiction is easily understandable by the driver, who will find this change less distracting.

In addition, the change in scaling may be made dependent on the current magnitude of the value to be indicated. Thus, for example, the scale might depict a range of +/−20% around the current value.

The change of scaling can also be effected in such a way that the current position of the indicator is retained. In this way, the driver does not lose track of the indicator even with only fleeting visual contact, and can more reliably read the current value displayed on the instrument.

In one particular embodiment, the two ends of the circular dial change position as the scaling changes. This means that the angle range for the display decreases e.g. from both sides. This may be particularly advantageous with regard to retaining the current indicator position.

In a further embodiment, the scaling may be changed from linear, regarding distribution at the circumference, to non-linear. It is thus possible e.g. to shift to a logarithmic scaling in order to reduce the display surface occupied by the circular dial and gain additional space for the representation of other information.

In a further preferred embodiment, the circular dial is enclosed by a scaled ring, and this scaled ring is opened when the scaling is altered. This provides an optical indication that the scale is no longer using the complete circle, and that space is now available to represent other information even without overlapping displays.

Furthermore, in addition to the circular dial with the indicator, an image can be graphically represented on the display device, with the circular dial occupying a first section of a display surface of the display device before the change in scaling, and with a portion of the first section used to display the image after the change in scaling. Moreover, if desired, an additional circular dial may be depicted on the display device, in which case the scaling of both circular dials is changed and an area not needed to display values in consequence of the change in scaling is used or also used to depict the image. Thus, for example, the area between two circular dials could be better utilized in that the display areas are each displaced into the areas of the circular displays that are turned away from one another.

Exemplary embodiments of the present invention are also directed to a method to display a value and an image on a display device of a vehicle having a predetermined display surface, through graphical representation of a scale with a predetermined range of values in a first section of the display surface, graphical representation of an indicator pointing to value of the scale to be indicated, and graphical representation of the image in a second section of the display surface, with the second section projecting into the first section to a degree dependent on the value to be displayed, such that the image partially overlaps the scale.

It is thus possible in an advantageous manner for a scale range not presently needed to depict the current value to instead be used for other graphical depictions. A rescaling may be carried out to a certain degree, but is not a necessity.

The value to be indicated is preferably an RPM value, a speed value, a temperature value, or a fluid level. In general, any value relating to the vehicle or its environment may be displayed in this manner. In particular, the typical display forms may be retained, such as the use of an almost complete circle for speed and RPM indicators, or the use of partial circles e.g. for temperature and fluid level indicators.

Exemplary embodiments of the present invention are also directed to a display device to indicate a value in a vehicle having an imaging device for the graphical depiction of a circular dial with a predetermined range of values in a first angle range of a complete or partial circle, and for the graphical depiction of an indicator pointing to a value on the scale, and with a calculation device for changing the scaling of the circular dial, with the imaging device being capable of displaying the circular dial in a second angle range smaller than the first angle range, in keeping with the altered scaling.

Exemplary embodiments of the present invention are also directed to a display device for a vehicle to indicate a value and an image with an imaging device having a predetermined display surface for the graphical depiction of a scale with a predetermined range of values in a first section of the display surface, and for the graphical depiction of an indicator pointing to the value on the scale to be indicated, as well as for the graphical depiction of the image in a second section of the display surface, and with a calculation device to determine the extent to which the second section should project into the first section, dependent on the value to be indicated.

### BRIEF DESCRIPTION OF THE DRAWING FIGURES

The present invention shall now be explained in greater detail by means of the enclosed drawings, which depict as follows:

FIG. 1 a display on an instrument cluster in an initial state;

FIG. 2. the display on the instrument cluster after a rescaling; and

FIG. 3 a display on an instrument cluster utilizing the portion of the display not needed by a circular instrument.

### DETAILED DESCRIPTION

The exemplary embodiments detailed hereinafter represent preferred embodiments of the present invention.

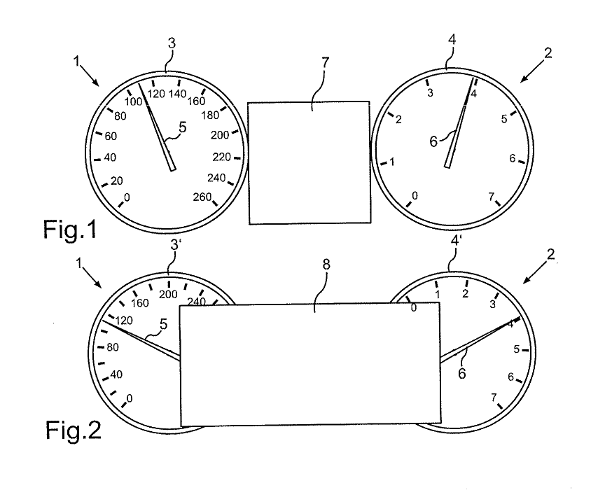

FIG. 1 depicts an example of an initial state with regard to the representation of instruments and other information on an instrument cluster. The instrument cluster has a large display screen on which a speedometer 1 and a tachometer 2 are depicted. Both are represented as virtual instrument tubes, and each possesses a scaled ring 3, 4. Within the scaled ring 3 of the tachometer or speedometer 1, evenly distributed along nearly the entire inner circumference, is a scale, which here indicates the speed values from 0 km/h to 260 km/h. An indicator 5 points to the current speed value (here, approximately 110 km/h).

In the right-hand section of the illustration is the tachometer 2, which also has a circular dial within its scaled ring 4, which here too is evenly distributed along the circumference. The circular dial shows the values 0 to 7, representing the RPM range from 0 RPM to 7,000 RPM. The indicator 6 of the circular instrument here points approximately to the scale value 4, corresponding to a RPM value of 4,000 RPM.

A usable display surface 7 for displaying images or other information is arranged between the speedometer 1 and the tachometer 2, or between their scaled rings 3 and 4. This usable display surface 7 is restricted in width in geometric terms to the distance between the two scaled rings 3 and 4. However, for many applications, it is too small to provide a clear depiction.

Thus, according to the exemplary embodiment of FIG. 2, the size of display necessary to depict e.g. a driver assistance system (in particular night view) is expanded to cover the usable display surface 8. Thus, usable display area would project into both the speedometer 1 and the tachometer 2. Accordingly, in the present example, an open scaled ring 3′ is now displayed, rather than the scaled ring as a complete circle. The center of the two scaled rings 3, 3′ is unchanged. The scaled ring 3′ is open on the side toward the usable display surface 8, thus this surface can more or less project into the scaled ring 3′.

While in the circular dial of FIG. 1 an angle range of approximately 270° is available (or is used) for the speedometer, in the case of FIG. 2, only approximately 180° are available for the circular dial. The circular dial must thus be rescaled accordingly in order that the full speed range continues to be displayed for the driver. In the present example, the scale marks thus move somewhat closer together, and every second scale value is omitted in comparison with those shown in FIG. 1, as less space is now available for their display. After rescaling, the scale value “110” is located at a different position than before rescaling. The indicator 5 must thus occupy a different position than before rescaling. However, this applies only for the type of scaling chosen here; with different scaling, the indicator position could also be retained (see below).

The scaled ring 4′ of the tachometer 2 was also opened at the side toward the speedometer 1. Additional space for the usable display surface 8, which also somewhat projects into the scaled ring 4′, is also created thereby in the area of the tachometer 2. Accordingly, the full range of the scaled ring 4′ is no longer available, a rescaling was carried out. Much as in the case of the speedometer 1, approximately 270° of the complete circle were used by the tachometer 2 before rescaling. After rescaling, only approximately 180° of the complete circle are used. Due to the reduced angle range of the overall scale, the scale marks on the inner circumference of the scaled ring 4 move closer together.

For the speedometer 1, the speed value “0” is located in the same position before and after rescaling. Only the maximum value “260” occupies a new angular position after rescaling. For the tachometer 2, by contrast, the maximum value “7” was retained in the same position. Only the angular position of the starting value “0” has changed as a result of rescaling. Thus, depending on the desired functionality, the angular position of the highest or lowest value of the scale may be changed, or even both.

The display is thus transformed from the representation shown in FIG. 1 to that shown in FIG. 2. This may occur by simply switching from one to the other, or by an appropriate animation.

The previously closed scaled rings 3 and 4 are opened in the exemplary embodiment in that the scaling contained therein is compressed into a previously determined aperture angle (=rescaling). The opened scaled rings create room for a larger, more easily comprehended representation of display information. This is thus more legible, as the display surface located between the scaled rings has been temporarily expanded.

As previously indicated, this rescaling is preferably effected while retaining the current indicator position. The scaling may be compressed from both sides, or a non-linear scale may be selected for display, such as a logarithmic scale, which then occupies a smaller angle range than the original linear scaling.

In the example of FIG. 2, the scaled ring 3′ or 4′ has been opened. In another exemplary embodiment, the scaled ring in question remains closed, the usable display surface 8 overlaps the scaled rings or scaled ring, and only the scaling inside the scaled ring in question is changed.

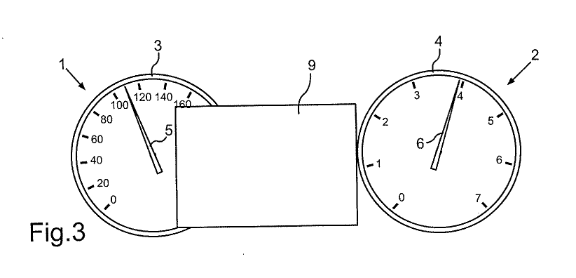

According to the exemplary embodiment of FIG. 3, a speedometer 1 and a tachometer 2 are also depicted as instrument tubes on the instrument cluster. The layout of the instrument tubes, including the scaling and the indicator 5, 6, corresponds to that of the example of FIG. 1. However, it is intended that more space be made available for displaying an image or other information than in the example of FIG. 1. As the portion of the speedometer in the range above 160 km/h is not currently in use here, the display area extending almost to the middle of the speedometer 1 can be used for displaying other information. Together with the area between the two instrument tubes (see FIG. 1), this provides an expanded usable display surface 9. Here, too, the expansion may be carried out by means of animation.

If, for example, the current value for the speed of the vehicle is only 50 km/h, the expanded usable display surface 9 could be extended further to the left. This could be used e.g. for a parking assistance system, which is not typically used at speeds above 50 km/h. The adjustment of the usable display surface 9 to the current speed could be effected e.g. in one, two, or three stages, with a suitable speed range and corresponding display surface to be defined for each stage.

In the example of FIG. 3, the expansion of the display surface 9 is effected only in one direction, toward the left. However, an expansion toward the right is also conceivable, depending on the magnitude of the value currently displayed on the right-hand circular dial.

In an advantageous manner, then, no change in visual perception occurs, and the normal layout of the instruments is retained. In particular, no switch from a ring to a bar tachometer occurs. Furthermore, no distortions result (as occur when attempts are made to economize on space by using slanted displays), and there is no need to omit displaying certain instruments due to a lack of space. Above all, the display surface freed up in the manner permits a larger-sized, more detailed, more easily comprehensible representation of complex information.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for display a value on a display device of a vehicle, comprising:
graphically representing a circular dial with a predetermined range of values in a first angle range of a full or partial circle;
graphically representing an indicator, which points to the value of the circular dial to be indicated; and
graphically representing the circular dial with an altered scaling having a second angle range that is smaller than the first angle range.

12. The method according to claim 11, wherein a transition between the graphical representation of the circular dial with the first angle range to the second angle range is effected via animation.

13. The method according to claim 11, wherein the alteration of the scaling is dependent on a current magnitude of a value to be indicated by the graphical representation.

14. The method according to claim 11, wherein:
the scaling is altered in such a manner that a current position of the indicator is maintained;
positions of two ends of the circular dial are changed when the scaling is altered;
the scaling is altered from a linear distribution of scale marks along a circumference of the circular dial to a non-linear distribution; or
a scaled ring surrounding the circular dial is opened when the scaling is altered.

15. The method according to claim 11, further comprising:
graphically representing an image on the display device, wherein with the circular dial occupies a first section of a display surface of the display device before the scaling is altered, and a part of the first section is used to display the image after the scaling is altered.

16. The method according to claim 15, further comprising:
graphically displaying an additional circular dial on the display device, wherein a scaling of both circular dials is altered, and an area not used to display values on the circular dial and the additional circular dial after the scaling is altered is used to display the image.

17. A method for displaying a value and an image on a display device of a vehicle having a predetermined display surface, comprising:
graphically depicting a scale with a predetermined range of values in a first section of the display surface;
graphically depicting an indicator pointing to a value of the scale to be indicated; and
graphical depicting the image in a second section of the display surface, wherein the second section projects into the first section to a degree dependent on the value to be displayed, such that the image partially overlaps the scale.

18. The method according to claim 17, wherein the value to be indicated is an RPM value, a speed value, a temperature value, or a fluid level.

19. A display device for displaying a value in a vehicle, comprising:
an imaging device configured to graphically depict a circular dial with a predetermined range of values in a first angle range of a complete or partial circle, to graphically depict an indicator pointing to a value on the circular dial; and
a calculation device configured to change the scaling of the circular dial,
wherein the imaging device is configured to display the circular dial in a second angle range smaller than the first angle range consistent with the changed scale.

20. A display device for a vehicle for displaying a value and an image, comprising:
an imaging device having a predetermined display surface configured to graphically depict a scale with a predetermined range of values in a first section of the display surface, an indicator pointing to the value on the scale to be indicated, and the image in a second section of the display surface; and
a calculation device configured to determine an extent to which the second section should project into the first section dependent on the value to be indicated.
